(19) United States
(12) Patent Application Publication
(10) Pub. No.: US 2015/0044384 A1
(43) Pub. Date: Feb. 12, 2015

(54) COATING APPARATUS AND COATING METHOD

(71) Applicant: FUJITSU LIMITED, Kawasaki-shi (JP)

(72) Inventors: Satoshi Kai, Kawasaki (JP); Keisuke Ueda, Kawasaki (JP)

(21) Appl. No.: 14/336,111

(22) Filed: Jul. 21, 2014

(30) Foreign Application Priority Data
Aug. 6, 2013 (JP) 2013-163628

(51) Int. Cl. B05C 3/18; B05D 1/18

(52) U.S. Cl. CPC B05C 3/18; B05D 1/18
USPC 427/430.1; 118/400

(57) ABSTRACT

A coating apparatus includes a first water repellent portion that is formed on a liquid supply surface provided in a liquid supply platform to once retain a liquid to be transferred to a coating object, and a hydrophilic portion that is formed around the first water repellent portion. Further, a coating method includes supplying a liquid to a top surface of a liquid supply platform, which is a liquid supply surface formed with a water repellent portion and a hydrophilic portion disposed around the water repellent portion, and transferring by pressing a coating object of the liquid against the liquid that is retained by the liquid supply surface.

### CROSS-REFERENCE TO RELATED APPLICATION

This application is based upon and claims the benefit of priority of the prior Japanese Patent Application No. 2013-163628, filed on Aug. 6, 2013, the entire contents of which are incorporated herein by reference.

### FIELD

The embodiments discussed herein are related to a coating apparatus and a coating method.

### BACKGROUND

In the past, it is known apparatuses that coat an object with a liquid, for example, apparatuses that coat an adhesive coating surface with a liquid adhesive. In such apparatus, there are techniques provided with a water repellent film in a stamp body having a facing surface that faces a surface on which adhesive is applied (for example, refer to Japanese Laid-open Patent Publication No. 54-155235 which has been published as Japanese Examined Patent Application Publication No. 61-14873). In addition, as a technique to coat with an ink, which is a liquid, there are application needles provided with a water repellent finishing layer, thereby enhancing fluidity and transferability of the ink (for example, Japanese Laid-open Patent Publication No. 2008-155180).

### SUMMARY

According to an aspect of the invention, a coating apparatus includes a first water repellent portion that is formed on a liquid supply surface provided in a liquid supply platform to once retain a liquid to be transferred to a coating object, and a hydrophilic portion that is formed around the first water repellent portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an illustrative diagram illustrating a schematic configuration of a coating apparatus in an embodiment;

FIG. 2A is a plan view of an adhesive supply platform provided with an adhesive supply surface, and FIG. 2B is a cross-sectional view taken along line IIB-IIB in FIG. 2A;

FIGS. 3A through 3C are illustrative diagrams illustrating a situation of supplying an adhesive to an adhesive supply surface;

FIGS. 4A through 4F are illustrative diagrams illustrating a situation of coating an optical device with an adhesive by transfer;

FIG. 5 is a flowchart illustrating one example of a coating method of an adhesive using the coating apparatus in the embodiment;

FIG. 6 is an illustrative diagram illustrating a procedure of supplying an adhesive by the coating apparatus in the embodiment;

FIG. 7 is illustrative diagram illustrating a procedure of transferring an adhesive by the coating apparatus in the embodiment;

FIG. 8 is an illustrative diagram illustrating a procedure of implementation by the coating apparatus in the embodiment;

FIGS. 9A through 9D are illustrative diagrams illustrating a situation of adjusting an amount of supplying an adhesive by the coating apparatus in the embodiment;

FIG. 10A is a plan view illustrating an example of another adhesive supply platform, and FIG. 10B is a cross-sectional view taken along line XB-XB in FIG. 10A; and

FIG. 11 is an illustrative diagram illustrating an example of another adhesive supply platform.

### DESCRIPTION OF EMBODIMENTS

For example, when a liquid, such as an adhesive, is coated on an object by transfer, the amount of liquid to be transferred to the object sometimes varies due to a large amount of residual liquid in a retainer that retains the liquid once. Regarding such problem, it is considered to provide a portion having water repellency for the portion that retains the liquid once as in Japanese Examined Patent Application Publication No. 61-14873 (Japanese Laid-open Patent Publication No. 54-155235) and Japanese Laid-open Patent Publication No. 2008-155180 above. However, only by providing a portion simply having water repellency, there is a concern that the supplied liquid is repelled and it is not possible to stably retain the liquid.

Accordingly, there is desired a coating apparatus and a coating method disclosed that stably retain a liquid in a liquid supply platform with decrease of an amount of residual liquid that is supplied to the liquid supply platform and served for transfer. It is also possible to regard, not limited to the problems above, exhibition of an action effect that is led by each configuration described in embodiments described later and that is not obtained by the techniques in the past as one of other problems of the present disclosure.

Descriptions are given below to embodiments of the present disclosure with reference to the attached drawings. In the drawings, dimensions, ratios, and the like of each portion are sometimes not illustrated so as to perfectly agree with actual ones. Depending on the drawings, actually existing components are sometimes omitted for ease of understanding.

### Embodiment

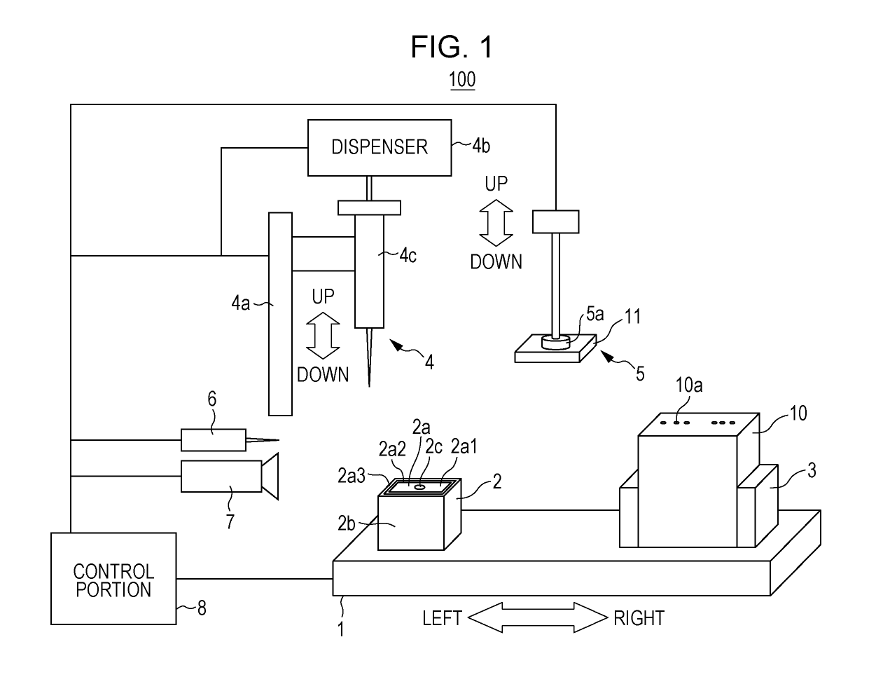

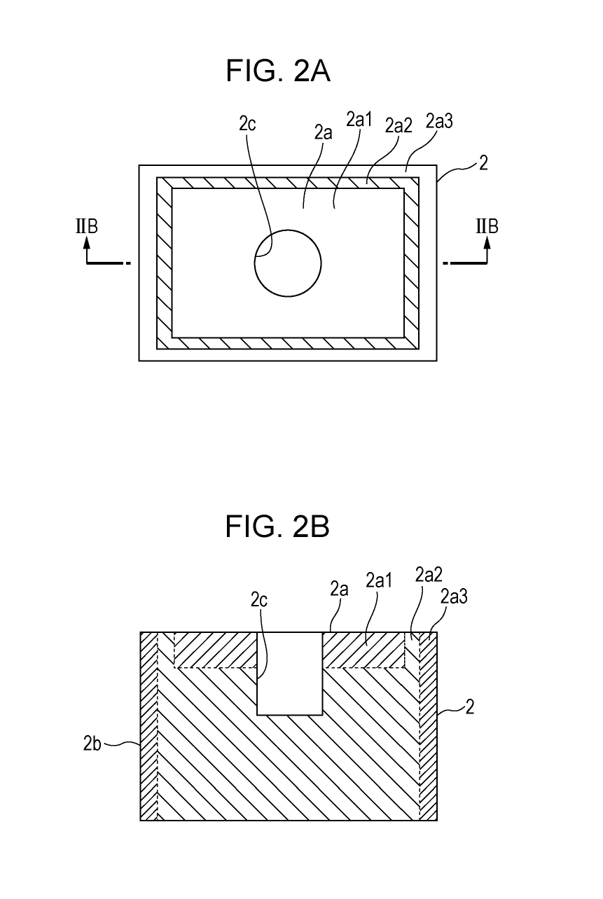

FIG. 1 is an illustrative diagram illustrating a schematic configuration of a coating apparatus 100 in an embodiment. FIG. 2A is a plan view of an adhesive supply platform 2 provided with an adhesive supply surface 2a, and FIG. 2B is a cross-sectional view taken along line IIB-IIB in FIG. 2A. The coating apparatus 100 in the embodiment is capable of coating an optical device, such as a photodiode (PD), hereinafter, simply referred to as an optical device, with an adhesive, which is a liquid, by transfer. That is, a coating object of the coating apparatus 100 in the embodiment is an optical device 11. The coating apparatus 100 is capable of carrying out up to a procedure of implementing the optical device 11 coated with an adhesive in a base part 10 provided with an optical waveguide 10a. Examples of the base part 10 may include, for example, a planar lightwave circuit (PLC). In such a manner, while the coating apparatus 100 in the embodiment is used for applications of coating a part used for an electronic device with an adhesive by transfer, it is also possible to apply for transfer of another liquid, for example, an ink or the like to a coating object.

The coating apparatus 100 includes the adhesive supply platform 2 that once retains an adhesive to be transferred to the optical device 11. The adhesive supply platform 2 is equivalent to a liquid supply platform. The coating apparatus 100 includes a moving stage 1 disposed movably in right and left directions in FIG. 1. The adhesive supply platform 2 is disposed on the moving stage 1. A top surface of the adhesive supply platform 2 is the adhesive supply surface 2a equivalent to a liquid supply surface. Referring to FIG. 2A, in the adhesive supply surface 2a, a first water repellent portion 2a1 is formed. In addition, around the first water repellent portion 2a1, a hydrophilic portion 2a2 is formed. Further, around the hydrophilic portion 2a2, a second water repellent portion 2a3, which is one example of a wetting avoiding portion, is formed. The second water repellent portion 2a3 continues to side surfaces 2b of the adhesive supply platform 2. In a central area of the adhesive supply surface 2a, an adhesive retaining portion 2c in a concave shape is provided.

The first water repellent portion 2a1 is provided to improve detachability of the adhesive. The improvement of the detachability of the adhesive improves the transferability of the adhesive. The hydrophilic portion 2a2 is easily contacted by the adhesive and thus divides or defines the region to retain the adhesive. The second water repellent portion 2a3 is provided around the hydrophilic portion 2a2, thereby dividing or defining the region to retain the adhesive more clearly. The hydrophilic portion 2a2 in the present embodiment is formed in rectangular ring-shape around the first water repellent portion 2a1. By making the hydrophilic portion 2a2 in rectangular ring-shape, it becomes easier to retain the adhesive therein. It is to be noted, though, that the hydrophilic portion 2a2 may have a shape capable of retaining an adhesive. That is, the hydrophilic portion 2a2 is not expected to have a perfect seamless rectangular ring-shape, and may also be in a shape provided partially with, for example, a notch. The shape of the hydrophilic portion 2a2 may be modified in conformity with the shape of the object to transfer the adhesive. In the present embodiment, the hydrophilic portion 2a2 is formed in a rectangular shape in conformity with the shape of the optical device 11.

The hydrophilic portion 2a2 may be in a relatively high hydrophilic condition compared with the first water repellent portion 2a1 and the second water repellent portion 2a3. For example, the surface roughness of the hydrophilic portion 2a2 may be in a condition rougher than the surface roughness of the first water repellent portion 2a1 and the second water repellent portion 2a3. The first water repellent portion 2a1 and the second water repellent portion 2a3 may also be provided with a surface layer of a material having water repellency on the surface and the other hydrophilic portion 2a2 may also be in an untreated condition. As the material having water repellency, it is possible to employ, for example, polytetrafluoroethylene (PTFE) and a tetrafluoroethylene-perfluoro alkyl vinyl ether copolymer (PFA). The point is to be capable of distinguishing a highly hydrophilic portion from a highly water repellent portion. As long as the highly hydrophilic portion and the highly water repellent portion are distinguished from each other, it is not so important what material and surface treatment are used for the hydrophilic portion 2a2, the first water repellent portion 2a1, or the second water repellent portion 2a3.

The adhesive retaining portion 2c includes a concave shape. The adhesive retaining portion 2c is surrounded by the first water repellent portion 2a1 on the periphery. The first water repellent portion 2a1 easily repels an adhesive immediately after starting supply of the adhesive to the adhesive supply surface 2a due to its water repellency. Therefore, when no treatment has not been made, it is considered that the adhesive does not easily remain on the adhesive supply surface 2a. With that, the retention of the adhesive is improved by providing the adhesive retaining portion 2c. It is also possible to provide a plurality of adhesive retaining portions 2c.

On the moving stage 1, a base part fixing portion 3 is provided. The base part fixing portion 3 fixes the base part 10 by vacuum suction. The coating apparatus 100 includes an adhesive supply portion 4. The adhesive supply portion 4 includes an elevating and lowering guide portion 4a, a dispenser 4b, and a supply nozzle portion 4c. The coating apparatus 100 includes a workpiece retaining portion 5. The workpiece retaining portion 5 includes a suction hand portion 5a. The workpiece retaining portion 5 is capable of moving to elevate and lower the optical device 11 that is retained by the suction hand portion 5a. The coating apparatus 100 includes an intake nozzle portion 6, an imaging portion 7, and a control portion 8. The intake nozzle portion 6 is capable of adjusting the amount of adhesive by sucking a part of the adhesive when the amount of adhesive supplied on the adhesive supply surface 2a is too much. The imaging portion 7 is used for taking an image of the adhesive supplied on the adhesive supply surface 2a to determine the amount of adhesive. The imaging portion 7 may also be used for measurement of an inclination of the adhesive coating surface of the optical device 11. The control portion 8 is electrically connected to the moving stage 1, the elevating and lowering guide portion 4a, the dispenser 4b, the workpiece retaining portion 5, the intake nozzle portion 6, and the imaging portion 7 to control the respective portions.

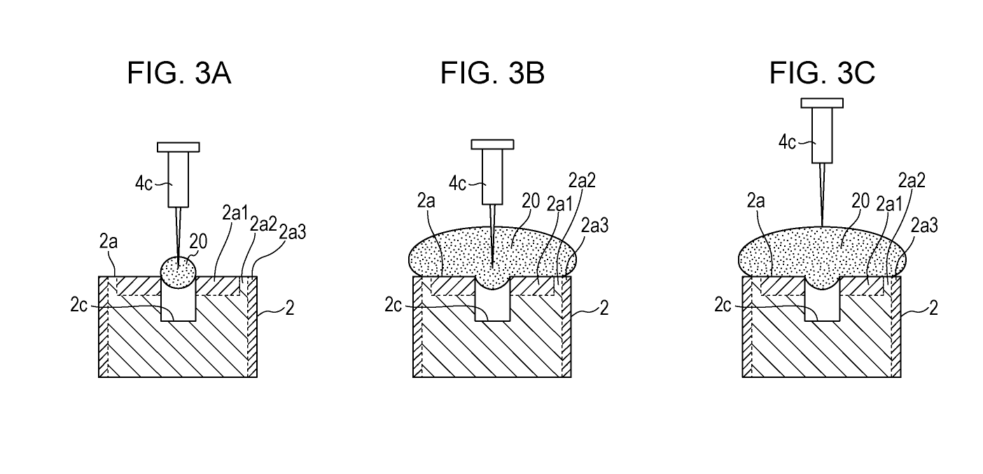

Here, with reference to FIGS. 3A through 3C, descriptions are given to the principle that the adhesive is retained on the adhesive supply surface 2a. FIGS. 3A through 3C are illustrative diagrams illustrating a situation of supplying an adhesive to the adhesive supply surface 2a. FIG. 3A illustrates a condition of starting ejection of an adhesive 20 towards the adhesive supply surface 2a from the supply nozzle portion 4c. The adhesive 20 ejected from the supply nozzle portion 4c is retained in the adhesive retaining portion 2c. That is, although the presence of the first water repellent portion 2a1, it is possible to retain the adhesive 20 on the adhesive supply surface 2a. Then, as illustrated in FIG. 3B, the adhesive 20 in a predetermined or certain amount is ejected from the supply nozzle portion 4c. At this time, since the residual adhesive of the last adhesive coating operation is in a trace amount, an approximately stable amount or specific amount of adhesive may be retained on the adhesive supply surface 2a by supplying the adhesive in a predetermined or certain amount defined in advance. When the supplied amount of the adhesive 20 is too much, the excess adhesive 20 overflows beyond the hydrophilic portion 2a2 to reach the second water repellent portion 2a3. Since the second water repellent portion 2a3 continues to a side surface 2b of the adhesive supply platform 2, the overflowed adhesive 20 falls down along the side surface 2b. The adhesive 20 on the adhesive supply surface 2a is contacted to the hydrophilic portion 2a2 and retained in a stable condition. After that, as illustrated in FIG. 3C, the supply nozzle portion 4c is retracted. Since the condition of the adhesive 20 contacted to the hydrophilic portion 2a2 is maintained even when the supply nozzle portion 4c is retracted, the adhesive 20 remains on the adhesive supply surface 2a in a stable condition.

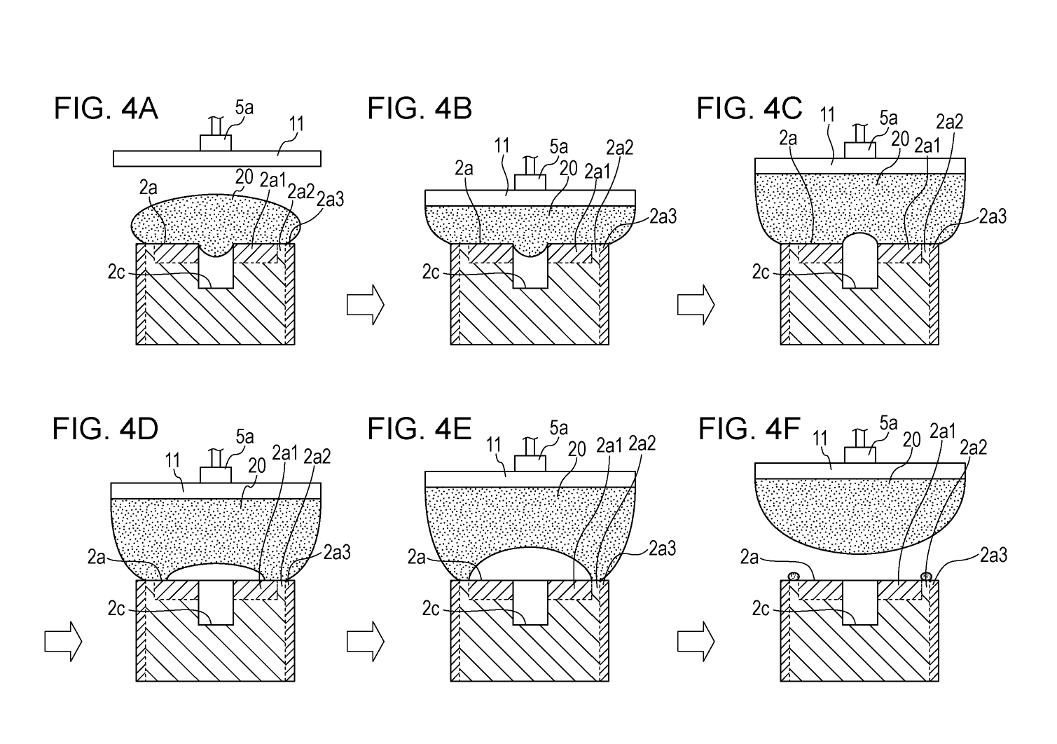

Next, with reference to FIGS. 4A through 4F, descriptions are given to the principle of transferring the adhesive 20 to the optical device 11 to be an adhesive coating object by transfer. FIGS. 4A through 4F are illustrative diagrams illustrating a situation of coating the optical device 11 with an adhesive by transfer. FIG. 4A illustrates a condition of the optical device 11 as a workpiece approaching to the adhesive 20 retained on the adhesive supply surface 2a. FIG. 4B illustrates a condition of the optical device 11 making contact with the adhesive 20. Then, as illustrated in FIG. 4C, the optical device 11 is lifted after pressed against the adhesive 20. Then, as illustrated in FIG. 4D, the adhesive 20 starts leaving from the first water repellent portion 2a1. After that, when the optical device 11 is further lifted as illustrated in FIG. 4E, the adhesive 20 becomes to be retained in a condition where the adhesive 20 is in contact with only the hydrophilic portion 2a2. Then, finally, as illustrated in FIG. 4F, the adhesive 20 is separated from the adhesive supply surface 2a to be transferred to the optical device 11. At this time, the adhesive supply surface 2a side is in a condition that a slight adhesive resides in the hydrophilic portion 2a2. Since the adhesive 20 contacts with the adhesive supply surface 2a in a very small contact area immediately before the adhesive 20 is separated from the adhesive supply surface 2a, the variation in the amount of adhesive to be transferred is suppressed. In addition, since the residual adhesive is in a trace amount, the influence to the amount of next adhesive supply is very small, and the variation is also small. Therefore, it may be possible to stabilize the amount of retaining the adhesive for the next adhesive supply.

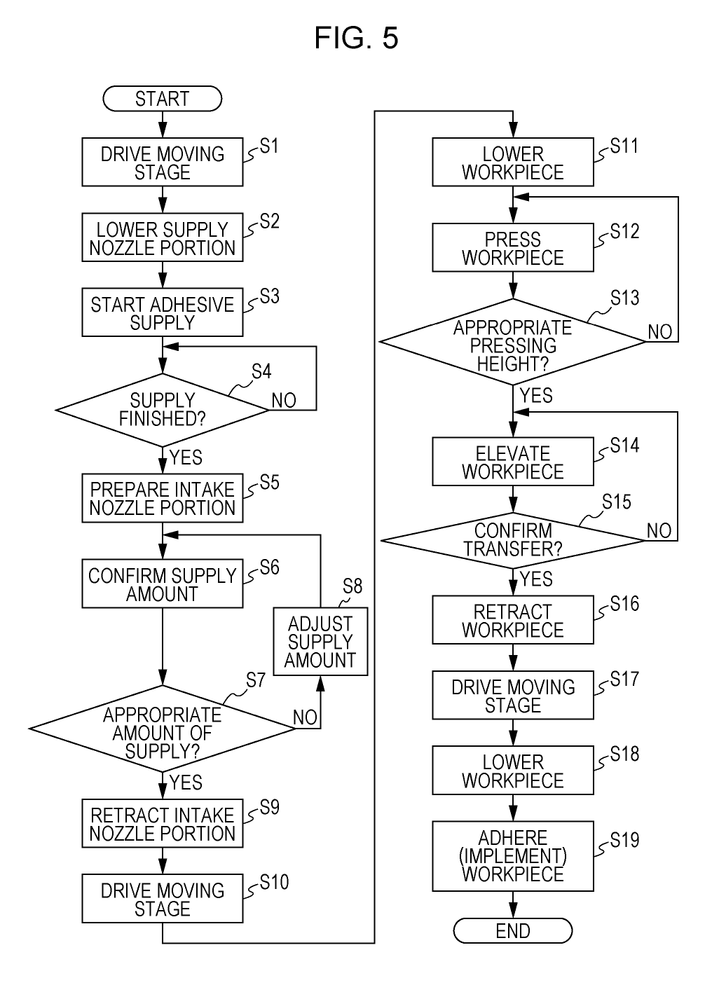

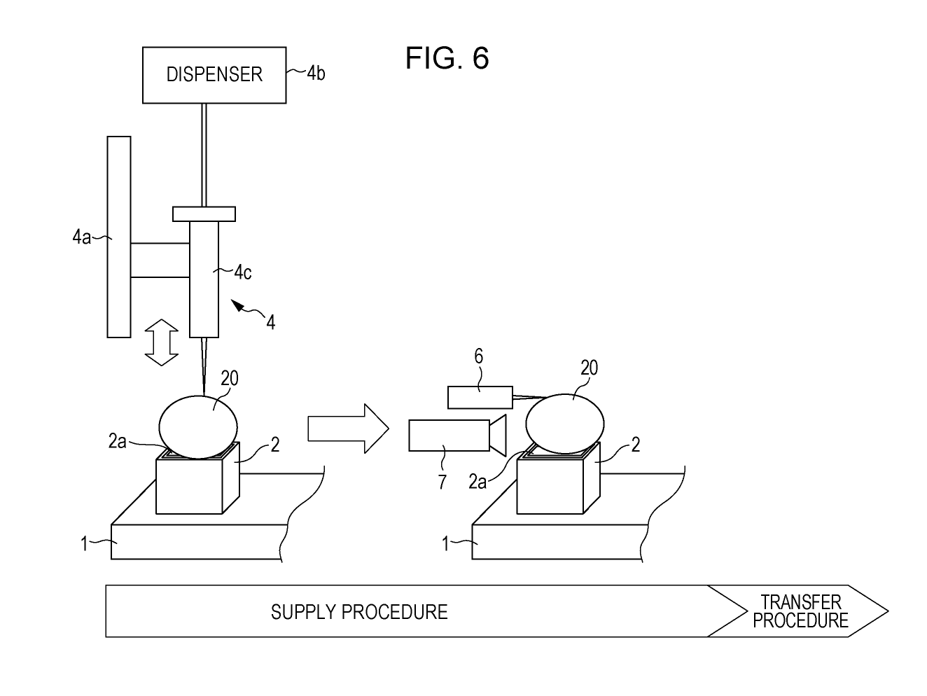

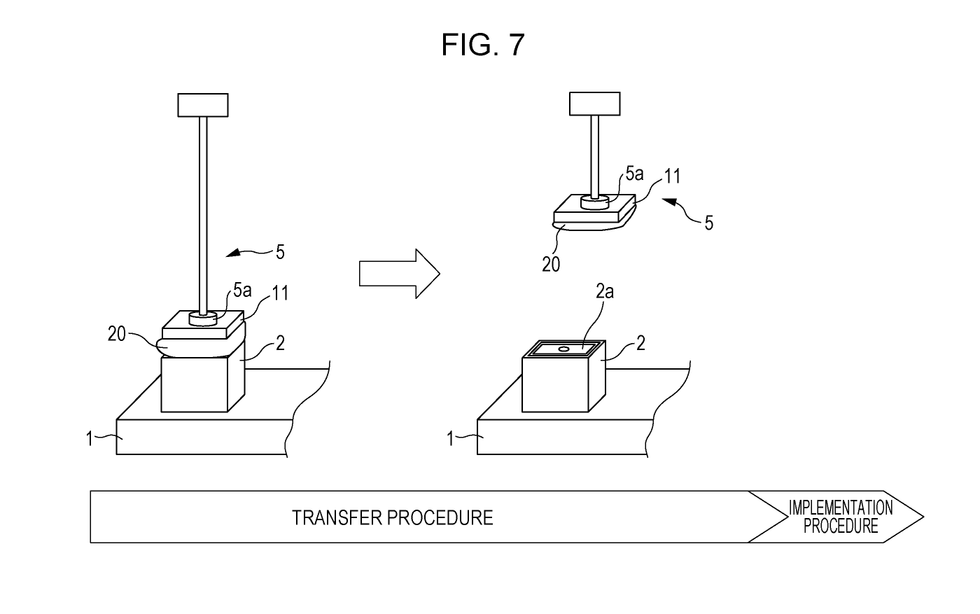

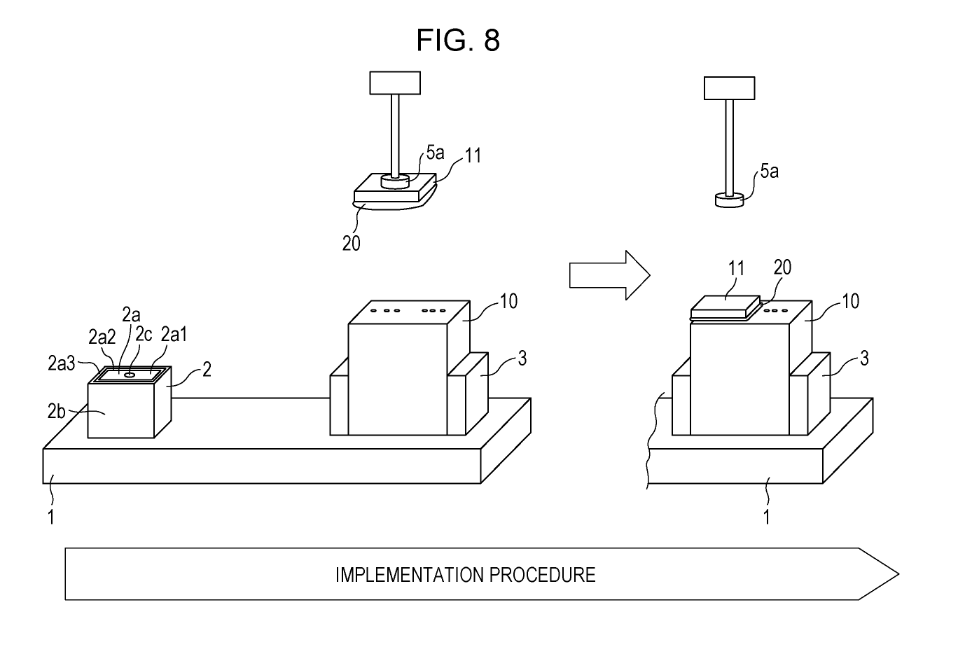

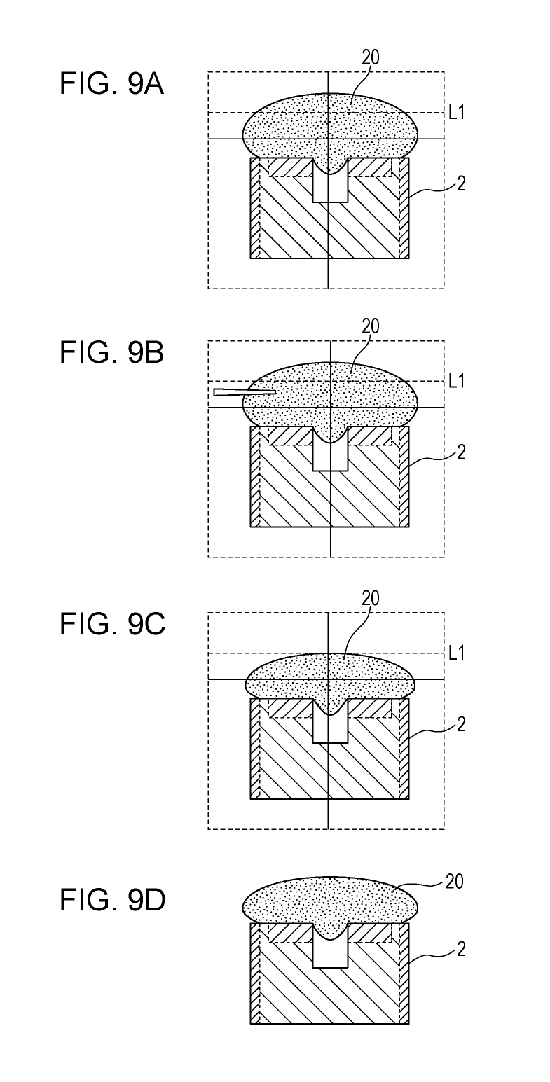

Next, with reference to FIGS. 5 through 9D, descriptions are given to one example of a method of coating an adhesive using the coating apparatus 100 in the embodiment. FIG. 5 is a flowchart illustrating one example of a method of coating an adhesive using the coating apparatus 100 in the embodiment. FIG. 6 is an illustrative diagram illustrating a procedure of supplying an adhesive by the coating apparatus 100 in the embodiment. FIG. 7 is an illustrative diagram illustrating a procedure of transferring an adhesive by the coating apparatus 100 in the embodiment. FIG. 8 is an illustrative diagram illustrating an implementation procedure by the coating apparatus 100 in the embodiment. FIGS. 9A through 9D are illustrative diagrams illustrating a situation of adjusting an amount of supplying an adhesive by a coating apparatus in the embodiment. Behaviors of the coating apparatus 100 is subjectively controlled by the control portion 8.

Firstly, as a preparation stage, the base part 10 is fixed to the base part fixing portion 3 and also the optical device 11 is retained by the suction hand portion 5a of the workpiece retaining portion 5. Then, in step S1, the moving stage 1 is driven to position the adhesive supply platform 2 immediately below the supply nozzle portion 4c of the adhesive 20. Subsequently, in step S2, the supply nozzle portion 4c is lowered by the elevating and lowering guide portion 4a. In step S3 performed successively from step S2, the dispenser 4b is activated to start supply of the adhesive 20. Therefore, as illustrated in FIG. 6, the adhesive 20 is supplied on the adhesive supply surface 2a. The adhesive 20 is retained on the adhesive supply surface 2a as described above. In step S4 performed successively from step S3, it is determined whether or not adhesive supply in a predetermined amount by the dispenser 4b is completed. The process in step S4 is repeated until determined as yes. After determined as yes in step S4, the process goes on to step S5.

In step S5, preparation of the intake nozzle portion 6 is carried out. Specifically, the intake nozzle portion 6 is approached to the adhesive 20. Then, in step S6, the amount of adhesive 20 supplied on the adhesive supply surface 2a at that time is confirmed. In step S7, it is determined whether or not the amount of supplying the adhesive 20 is an appropriate amount. Here, with reference to FIGS. 9A through 9D as well, descriptions are given to the method of confirming the amount of supplying the adhesive 20. Firstly, in step S6, as illustrated in FIG. 9A, an image of the adhesive 20 taken by the imaging portion 7 is superimposed to a line L1 illustrating an optimum amount of the supply amount. When the position of the apex of the adhesive 20 exceeds the line L1, determination is made as no in step S7. When determined as no in step S7, the process goes on to step S8. In step S8, as illustrated in FIGS. 6 and 9B, the intake nozzle portion 6 is made contact with the adhesive 20 to reduce the amount of the adhesive 20. Then, again, the process in steps S6 and S7 is repeated. As a result, when determination is made as yes in step S7, that is, the apex of the adhesive 20 agrees with the line L1 as illustrated in FIG. 9C to be in a condition illustrated in FIG. 9D, the process goes on to step S9. In step S9, the intake nozzle portion 6 is retracted. The process from step S1 to step S9 is a procedure of supplying the adhesive 20, that is, a supply procedure to supply the adhesive 20 to the top surface of the adhesive supply platform 2, which is the adhesive supply surface 2a having the first water repellent portion 2a1 and the hydrophilic portion 2a2 formed therearound.

In step S10 performed successively from step S9, the moving stage 1 is driven to position the adhesive supply platform 2 immediately below the workpiece retaining portion 5. Then, in step S11, the optical device 11 as a workpiece is lowered. After that, in step S12, the optical device 11 is further lowered to be pressed against the adhesive 20 as illustrated in FIG. 7. In step 513, it is determined whether or not the height attained by pressing is appropriate. The determination of the height attained by pressing may be assessed from the amount of lowering the workpiece retaining portion 5 and may also be determined by the image taken by the imaging portion 7. When determined as no in step S13, the process from step S12 is repeated. When determined as yes in step S13, the process goes on to step 514. In step 514, the optical device 11 retained by the workpiece retaining portion 5 is lifted as illustrated in FIG. 7, and in step S15, whether or not the transfer is completed is confirmed. When determined as no in step S15, the process from step 514 is repeated. The determination as yes in step S15 signifies that the transfer is completed. The process until determined as yes in step S10 through step S15 is the procedure of transferring an adhesive, that is, a transfer procedure to press the optical device 11, which is a coating object of the adhesive 20, against the adhesive 20 that is retained by the adhesive supply surface 2a.

When determined as yes in step S15, the process goes on to step 516. In step S16, the optical device 11 is once retracted upward. Then, in step

S17, the moving stage 1 is driven to position the base part 10 fixed to the base part fixing portion 3 immediately below the workpiece retaining portion 5. Then, the optical device 11 is lowered in step S18, and the optical device 11 is mounted on the base part 10 for adhesion in step S19. This completes the implementation of the optical device 11 in the base part 10. The process from step S16 to step S19 is the implementation procedure.

As just described, according to the coating apparatus 100 in the embodiment, it may be possible to reduce the residual amount of an adhesive that is supplied to the adhesive supply platform 2 and served for transfer while the liquid is stably retained in the adhesive supply platform 2. In such a manner, it may be possible to stably retain an adhesive, and by reducing the residual amount of adhesive, it is possible to suppress the variation in the amount of adhesive to be transferred. As a result, it may be possible to appropriately manage the amount of adhesive that is pushed out of the periphery of the optical device 11 when the optical device 11 is implemented in the base part 10. Thus, spread of the adhesive and the crawl of the adhesive up on the upper surface of the optical device 11 may be suppressed, and it may be possible to be applied to high density packaged devices.

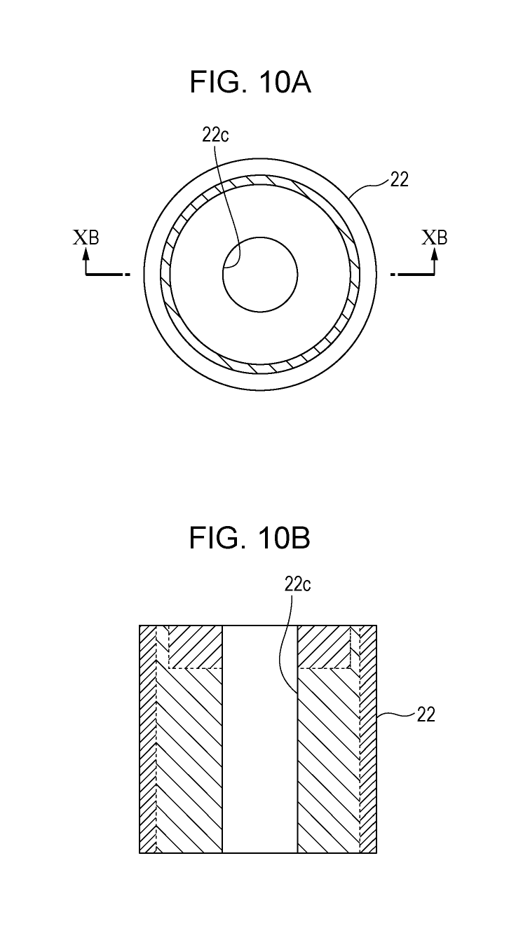

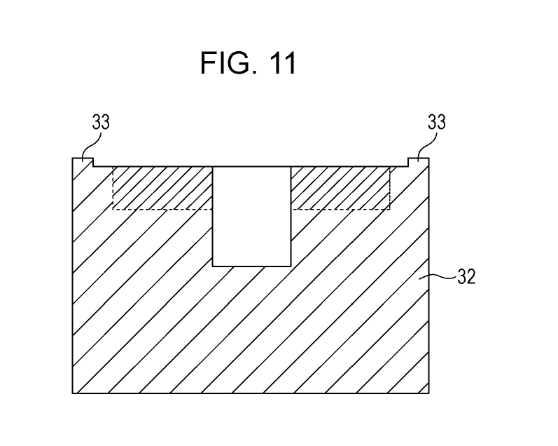

Although the adhesive supply platform 2 in the above embodiment is in a rectangular shape, it is also possible to be, for example, a circular adhesive supply platform 22 as illustrated in FIG. 10A and FIG. 10B in accordance with the shape of the part to which the adhesive is transferred. In addition, although the adhesive retaining portion 2c provided in the adhesive supply platform 2 in the above embodiment is concave, it is also possible to be a hole 22c as illustrated in FIG. 10B. That is, the adhesive retaining portion may be made easily retaining the adhesive than the first water repellent portion in the periphery. The adhesive supply platform 2 in the above embodiment is provided with the second water repellent portion 2a3 as a wetting avoiding portion in the outermost area of the adhesive supply surface 2a to be a top surface. Instead of the second water repellent portion 2a3, as a wetting avoiding portion, a wall portion 33 provided in the outermost area may also be provided as an adhesive supply platform 32 illustrated in FIG. 11.

While preferred embodiments of the present disclosure have been described in detail, embodiments of the present disclosure are not limited to such specific embodiments and various alterations and modifications are allowed within the scope of the summary of the embodiments of the present disclosure described in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A coating apparatus comprising:
a first water repellent portion that is formed on a liquid supply surface provided in a liquid supply platform to once retain a liquid to be transferred to a coating object; and
a hydrophilic portion that is formed around the first water repellent portion.

2. The coating apparatus according to claim 1, wherein the hydrophilic portion is formed in a shape which surrounds the first water repellent portion.

3. The coating apparatus according to claim 1, further comprising:
a wetting avoiding portion that is formed around the hydrophilic portion.

4. The coating apparatus according to claim 3, wherein the wetting avoiding portion is a second water repellent portion.

5. The coating apparatus according to claim 4, wherein the second water repellent portion continues to a side surface of the liquid supply platform.

6. The coating apparatus according to claim 1, wherein the first water repellent portion is provided with a liquid retaining portion.

7. A coating method comprising:
supplying a liquid to a top surface of a liquid supply platform, which is a liquid supply surface formed with a water repellent portion and a hydrophilic portion disposed around the water repellent portion; and
transferring by pressing a coating object of the liquid against the liquid that is retained by the liquid supply surface.

8. A coating apparatus for coating a liquid to a component, the coating apparatus comprising:
a liquid repellent portion that is formed on a liquid supply surface provided in a liquid supply platform to once retain a liquid to be transferred to a component; and
a portion that is formed around the liquid repellent portion, an affinity for the liquid of the portion being higher than an affinity of the liquid repellent portion for the liquid.
